(19) United States
(12) Patent Application Publication
(10) Pub. No.: US 2003/0091306 A1
(43) Pub. Date: May 15, 2003

(54) Rod type polymer preform having radially-varying properties, process for the preparation thereof and apparatus therefor

(76) Inventor: In-Bae Kim, Seoul (KR)

Correspondence Address: David A Einhorn, Anderson Kill & Olick, 1251 Avenue of the Americas, New York, NY, 10020, US

(21) Appl. No.: 10/221,595

(22) PCT Filed: Mar. 21, 2001
(86) PCT No.: PCT/KR01/00445

(30) Foreign Application Priority Data
Mar. 21, 2000 (KR) 2000-14204

(51) Int. Cl. G02B 5/30

(52) U.S. Cl. 385/102; 264/1.31

(57) ABSTRACT

A rod type polymer preform with radially-varying properties, e.g., refractive index, which is useful for preparing a contaminant-free high-bandwidth graded-index plastic optical fiber (GI-POF) or optical rod lens, can be conveniently prepared by a method which comprises charging a reactive material into a cylindrical reactor, inducing a chemical reaction while rotating the cylindrical reactor, and repeating the charging and reaction procedure two or more times using chemically or compositionally different materials in each of the repeating step.

### FIELD OF THE INVENTION

The present invention relates to a polymer preform having radially-varying properties, which is useful for preparing a graded-index plastic optical fiber(GI-POF) in the field of communication or image transmission. Further, the present invention relates to a method of preparing the inventive polymer perform and an apparatus therefor.

### BACKGROUND OF THE INVENTION

Conventional optical fibers for communication systems are classified into single-mode glass optical fibers and multi-mode glass optical fibers. The single-mode glass optical fibers that have been widely used as long-distance and high-speed communication media are typically made of silica glass and have a small core diameter in the range of 5 to 10 micrometers. Consequently, accurate alignment and connection of the fibers with other optical communication components is extremely difficult and costly.

Multi-mode glass optical fibers, on the other hand, have diameters larger than single-mode glass fibers, and can be used for short-distance communications such as local area networks (LANs). Despite their larger diameter, however, interconnections are still costly, and the brittleness of the silica glass has limited their application. Thus, metallic cables such as twisted pair or coaxial cables are still used extensively for short-distance communications up to about 200 meters. However, these metallic cables cannot meet the anticipated future bandwidth requirement of several hundred MHz (for example, the asynchronous transfer mode [ATM] standard of 625 megabits per second).

Due to these reasons there has been considerable interest in developing plastic optical fibers (POF) for the short-distance communication applications, such as LANs. POF can have a core diameter of about 0.5 to 1.0 mm, which makes it possible to adopt injection-molded polymer connectors, drastically reducing the cost associated with interconnecting the POF to other system components.

A plastic optical fiber, which typically consists of a core layer and a cladding layer, can have a step-index (SI) structure or gradient-index (GI) structure in its refractive index profile. The bandwidth of a step-index plastic optical fiber (SI-POF) cannot be larger than that of metallic cables due to its large modal dispersion whereas a gradient-index plastic optical fiber (GI-POF) can have a much higher bandwidth due to their low modal dispersion. Thus, GI-POF has high potential as a next generation transmission medium for high bandwidth communication.

An interfacial gel polymerization process for preparing a GI-POF was introduced by professor Koike in 1988 (Koike, Y. et al., Applied Optics, vol. 27, 486(1988)), and many patent applications were filed thereafter: U.S. Pat. No. 5,253,323 issued to Nippon Petrochemicals Co.; U.S. Pat. No. 5,382,448 issued to Nippon Petrochemicals Co.; U.S. Pat. No. 5,593,621 issued to Yasuhiro Koike and Ryo Nihei; International Patent Publication WO 92/03750 by Nippon Petrochemical Co.; International Patent Publication WO 92/03751; Japan Laid-open Patent Publication No. 03-78706 by Mitsubishi Rayon; Japan Laid-open Patent Publication No. 04-86603 by Toray Ind., etc. The disclosed processes may be divided into two broad types:

1. Batch processes in which a preform is made with a gradient index from a polymeric composition comprising a polymer(s) and a low molecular weight additive and subsequently drawn into a fiber.

2. Extrusion processes followed by extraction or infusion of low molecular weight components in the radial direction.

The method of Koike belongs to the first type, and was successfully implemented in producing fibers with a measured bandwidth of 2.5 Gbits/second. Various processes of the second type have been also reported to be successful in achieving a high bandwidth.

In addition to the above-mentioned references, Park and Walker introduced another method for the fabrication of a GI-POF (U.S. patent application Ser. No. 08/929,161; PCT/US97/16172). This method is a kind of a coextrusion process which utilizes a special coextrusion die block called as a GRIN die block and creates a refractive index profile by mechanical mixing. Unlike the method of Koike, it is a continuous process. They reported that its viability had been demonstrated and it was under further development for commercialization (Park and Walker, 14^{th} Annual Meeting of the Polymer Processing Society, Yokohama, Japan, June 1998).

Recently, another new method was invented by Kim (see Korean Patent Application No. 99-9976). It is an innovative mixing method which uses a cylindrical container of a circular cross-section or other various geometrical shapes to create a relative concentration profile of two or more polymeric materials.

In order to maximize the bandwidth of a GI-POF, the refractive index profile of the fiber should have a certain profile similar to a parabolic shape. Theoretically, the optimum refractive index profile may be described by the following model known as a “power law” index variation (Halley, P., Fiber Optic Systems, J.Wiley and Sons (1987); and Olshansky, R. and D. B. Keck , Appl. Opt. 15(2), p 483-491 (1976)):

$$\begin{matrix}n ( r ) = {{n}_{1} [ 1 - 2 {Δ ( \frac{r}{a} )}^{g} ]}^{\frac{1}{2}} & for r \leq a \\ {n}_{2} & for r > a\end{matrix}$$

wherein, r is the radial distance from the fiber axis, a is the radius of the fiber, n₁ and n₂ are the refractive indices at r=0 and r=a, respectively, where n₁≧n₂. 2Δ=(n₁²−n₂²)/n₁² and, g is the power-law index which determines the refractive index profile as a function of radius.

In particular, when g is 2, the power law is called “parabolic law”. When the g value approaches 2, an optimum refractive index profile for the maximum bandwidth can be obtained. It can be shown that if a light signal in the form of a delta function is launched into a GI-POF, the maximum bandwidth, B is given by:

$$B = \frac{c}{0.088 L {n}_{1}} \cdot \frac{1}{{Δ}^{2}} ( bits \text{/} second )$$

wherein L is the length of the fiber, and c is the speed of light.

In theory, the bandwidth of a GI-POF is very sensitive to the value of g near the optimum value. Therefore, in manufacturing a GI-POF, the obtainable bandwidth of the GI-POF is directly related to the ability to control the g value.

In all processes to produce GI-POFs except the processes by Park and Walker and Kim, the refractive index profile is determined by the diffusion of a lower molecular material or the relative reactivity of two materials. Thus, most of the processes do not have the ability to control the g value or the radial refractive index profile. It has been claimed that the method by Park and Walker has the capability of controlling the g value and the refractive index profile by way of mechanically mixing two or more polymers using a particular extrusion die. However, this method has critical disadvantages in that it is difficult to produce an optical fiber with a low attenuation due to the complicated structure of the extrusion die and contaminants resulting from the thermal decomposition of polymers during the coextrusion process.

The main reason why an SI-POF has much smaller bandwidth than a GI-POF is due to its high modal dispersion. However, a POF having a multi-layer structure as described schematically in FIGS. 3a or 4a can reduce the modal dispersion and consequently has a higher bandwidth than an SI-POF. The product of Mitsubishi Rayon called Esca-μ is such a multi-layered POF or multistep-index POF, which is apparently produced by a coextrusion process. However, it has the problems of sharp interfaces between each layers and contamination introduced during the coextrusion process.

### SUMMARY OF THE INVENTION

It is, therefore, an object of the present invention to provide a rod type polymer preform having a smoothened profile of radially-varying properties, which is useful for preparing a contaminant-free high-bandwidth graded-index plastic optical fiber (GI-POF).

It is another object of the present invention to provide a method of preparing the inventive rod type polymer preform.

It is a further object of the present invention to provide an apparatus for preparing the inventive rod type polymer preform.

In accordance with one aspect of the present invention, there is provided a method of preparing a rod type polymer preform with radially-varying properties, which is used for preparing a contaminant-free high-bandwidth graded-index plastic optical fiber (GI-POF), which comprises: sequentially charging a reactive material into a cylindrical reactor, inducing a chemical reaction while rotating the cylindrical reactor, and repeating the sequential charging and reaction procedure two or more times.

In accordance with another aspect of the present invention, there is provided an apparatus for preparing a rod type polymer preform with radially-varying properties, which is used for preparing a contaminant-free high-bandwidth GI-POF, which comprises: a cylindrical reactor; sealing members for sealing both ends of the reactor; an injection port installed on the reactor to charge reactive materials into the reactor; a rotating device to rotate the reactor; and a means for inducing the chemical reaction of the materials charged in the reactor.

In accordance with other aspect of the present invention, there is provided a rod type polymer preform with radially-varying properties useful for preparing a contaminant-free high-bandwidth GI-POF, which is prepared by the inventive method and/or using the inventive apparatus.

In accordance with further aspect of the present invention, there is provided a contaminant-free high-bandwidth GI-POF or optical lens prepared from the inventive perform.

### BRIEF DESCRIPTION OF THE DRAWINGS

The above and other objects and features of the present invention will become apparent from the following description thereof, when taken in conjunction with the accompanying drawings wherein:

FIG. 1a is an ideal profile of a radially-varying property of a rod type polymer preform;

FIG. 1b is a schematic view of a rod type preform with radially-varying properties;

FIG. 2 is a schematic view of an apparatus for preparing a rod type polymer preform with radially-varying properties according to the present invention;

FIG. 3a is a schematic profile of a radially-varying property of a rod type polymer perform when the preform is made by repeating charging and reaction of reactive materials four times in accordance with the present invention, wherein the reaction in each step was carried out to the extent of nearly 100% conversion;

FIG. 3b is a schematic profile of a radially-varying property of a rod type polymer perform when the preform is made by repeating charging and reaction of reactive materials four times in accordance with the present invention, wherein the reaction in each step was carried out to the extent of less than the case described in FIG. 3a;

FIG. 4a is a schematic profile of a radially-varying property of a rod type polymer perform when the preform is made by repeating charging and reaction of reactive materials nine times in accordance with the present invention, wherein the reaction in each step was carried out to the extent of nearly 100%;

FIG. 4b is a schematic profile of a radially-varying property of a rod type polymer perform when the preform is made by repeating charging and reaction of reactive materials nine times in accordance with the present invention, wherein the reaction in each step was carried out to the extent of less than the case described by FIG. 4a;

FIG. 5a is a schematic view of the non-circular cross-section of the reacting material in the reactor during the first step of the repetitive processes in accordance with the present invention when the gravitational force is dominant over the viscous force of the material due to the low rotational speed of the reactor or the low viscosity of the material;

FIG. 5b is a schematic view of the circular cross-section of the reacting material in the reactor during the first step of the repetitive processes in accordance with the present invention when the viscous force is dominant over the gravitational force due to the high viscosity of the reacting material in the reactor;

FIG. 6a is a schematic view of the cross-section of the materials in the reactor which represents a rather sharp interface between the first and second layers due to a high degree of the conversion of the first-layer material prior to charging of the second-layer material; and

FIG. 6b is a schematic view of the cross-section of the materials in the reactor which represents a fuggy interface between the first and second layers, which is not as clear as in FIG. 6a due to the lower level of the conversion of the first-layer material than the case of FIG. 6a prior to charging of the second-layer material.

### DETAILED DESCRIPTION OF THE INVENTION

The present invention is characterized by charging and reacting raw materials to be polymerized into a rotating reactor in a stepwise manner. In the present invention, since the kind and relative amount of the materials charged into the reactor and the degree of reaction (i.e., conversion) in each step can be appropriately adjusted, the radial refractive index profile can be controlled as desired. Consequently, a rod type polymer perform prepared by the present invention is useful for producing not only a contamination-free, high bandwidth GI-POF but also optical lens.

The term “properties” of a polymer perform, herein, mean optical properties such as refractive index, as well as physical and chemical properties such as tensile strength, color, thermal expansion coefficient, and concentrations of specific components.

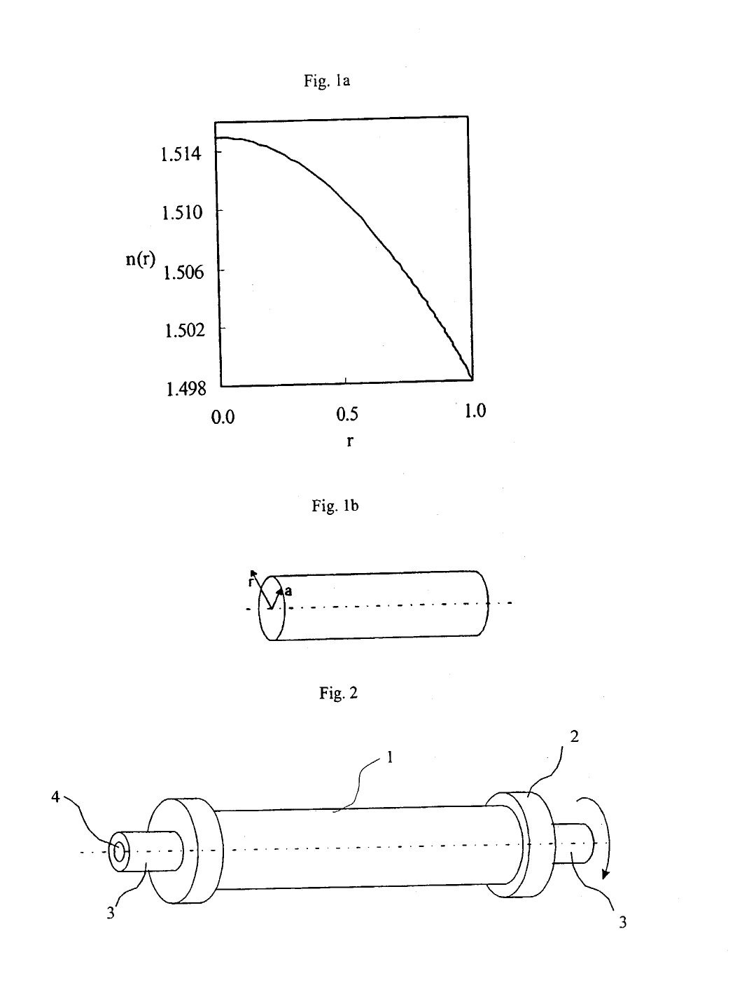

A rod type preform of a circular cross-section with radially-varying properties is schematically shown in FIG. 1b and an ideal radially-varying property of a rod type polymer perform is schematically shown in FIG. 1a. The perform prepared in accordance with the present invention can have a cross-section of a circular shape, or a triangular, rectangular, pentagonal, or other geometrical shape.

An apparatus for preparing a rod type polymer preform with radially-varying properties according to the present invention is schematically shown in FIG. 2. The apparatus comprises a cylindrical reactor(1), sealing members(2) for sealing both ends of the reactor, an injection port(4) installed on the reactor to charge reactive materials into the reactor, a rotating axis(3) connected to the reactor or the sealing members of the reactor, a rotating device (not shown) to rotate the reactor, and a means (not shown) for inducing the chemical reaction of the materials charged into the reactor.

The dimension of the reactor of the present invention may be suitably selected and it does not limit the present invention. When the chemical reaction in the reactor generates heat, the diameter of the reactor is preferably less than 15 cm for effective heat transfer. The length of the reactor is preferably smaller than 150 cm which is appropriate for the thermal drawing of the perform obtainable therefrom.

The rotation of the cylindrical reactor can be achieved by using a rotating device such as an electrical or a mechanical drive. The rotational axis of the reactor can be either vertical or horizontal relative to the direction of gravity. When the rotational axis is vertical, the rotational speed of the reactor is preferably so high enough to minimize the effect of gravity. Otherwise, the gravity effect results in non-uniformity of the properties of the perform in the axial direction. When the rotational axis is horizontal, on the other hand, it is possible to fabricate a rod type perform with radially-varying properties even at a low rotational rate while maintaining the uniformity in the axial direction.

The chemical reaction in the reactor may be induced by such means as a heating device or an UV radiation device, or a combination thereof. The reactor may be kept at a temperature of higher than room temperature by infrared radiation, a hot gas blower or a heating device of various types. The heating device may be a heating coil or a heating jacket.

The materials of the reactor and the sealing members may be Teflon™, glass, ceramic, aluminum, stainless steel, hastelloy, or brass.

The materials used in each step of the charging and reaction to prepare the rod type polymer preform in accordance with the present invention may be monomers, homopolymers, copolymers or mixtures thereof.

Representative examples of the monomers are methylmethacrylate, benzylmethacrylate, phenylmethacrylate, 1-methylcyclohexylmethacrylate, cyclohexylmethacrylate, chlorobenzylmethacrylate, 1-phenylethyl-methacrylate, 1,2-diphenylethylmethacrylate, diphenylethylmethacrylate, furfurylmethacrylate, 1-phenylcyclohexylmethacrylate, pentachlorophenyl-methacrylate, pentabromophenylmethacrylate, styrene, perfluoro-2,2-dimethyl-1,3-dioxole, tetrafluoroethylene, chlorotrifluoroethylene, vinylidene fluoride, hexafluoropropylene, trifluoroethylene, perfluoroallyl vinyl ether, and fluorovinyl ether. Homopolymers derived from the monomers mentioned above may be employed as materials for the reaction in the present invention.

Representative examples of the copolymers are methylmethacrylate(MMA)-benzylmethacrylate(BMA), styrene-acrylonitrile (SAN), methylmethacrylate(MMA)-2,2,2-trifluoroethylmethacrylate (TFEMA), methylmethacrylate(MMA)-2,2,3,3,3-pentafluoropropyl-methacrylate(PFPMA), methylmethacrylate(MMA)-1 1,1,3,3,3-hexafluoro-isopropylmethacrylate(HFIPMA), methylmethacrylate(MMA)-2,2,3,3,4,4,4-heptafluorobutylmethacrylate(HFBMA), trifluoroethylmethacrylate (TFEMA)-entafluoropropylmethacrylate(PFPMA), trifluoroethyl-methacrylate(TFEMA)-hexafluoroisomethacrylate(HFIPMA), and trifluoroethylmethacrylate(TFEMA)-heptafluorobutylmethacrylate(HFBNMA)

Further, examples of the copolymers include copolymers or terpolymers of perfluoro-2,2-dimethyl-1,3-dioxole and other monomers each selected from the group consisting of tetrafluoroethylene, chlorotrifluoroethylene, vinylidene fluoride, hexafluoropropylene, trifluoroethylene, perfluoroallyl vinyl ether, and fluorovinyl ether.

Further examples of the copolymers include copolymers or terpolymers of perfluoroallyl vinyl ether and other monomers each selected from the group consisting of perfluoro-2,2-dimethyl-1,3-dioxole, tetrafluoroethylene, chlorotrifluoro-ethylene, vinylidene fluoride, hexafluoropropylene, trifluoroethylene, and fluorovinyl ether.

In accordance with the present invention, a rod type polymer preform may be prepared as follows:

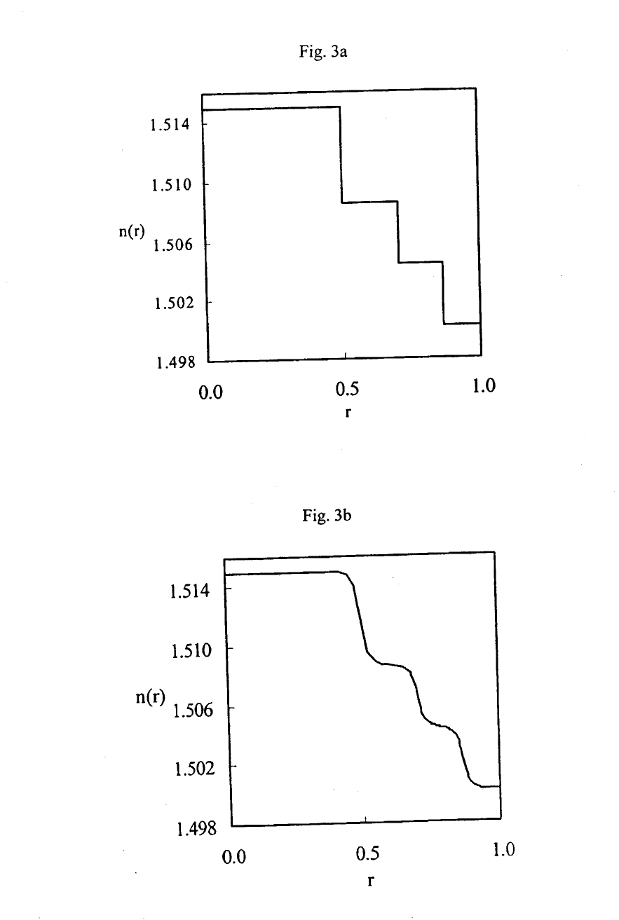

In a reactor(1) as shown in FIG. 2, a material or a mixture of two or more materials with a refractive index corresponding to the outer-most value of the desired GI-POF is charged into the reactor (1) through the injection port(4) at the end of a sealing member(2). The materials being charged may be liquid-phase thermoplastic polymers which have been completely polymerized and heated up to or above the melting points or the glass transition temperatures, incompletely polymerized prepolymers or oligomers, or monomers. The volume of the charged material is determined depending on the desired shape of the radial profile of the property and the number of charge-and-react steps used in the process. For example, when a four step procedure shown in FIG. 3b is adopted and the volume of the charged material in each step is the same, volume of the material charged in each step is one-fourth of the reactor volume.

Once the material for the first reaction step is charged into the reactor, a polymerization reaction is induced by UV-radiation and/or by heating the material in the reactor while the reactor is being rotated by a rotating device. The reactor may be rotated at a rate in the range of 10 to 2,000 rpm depending on the viscosity of the material in the reactor, and preferably in the range between 100 and 500 rpm.

The reaction temperature depends on the material to be reacted and on the degree of polymerization. For example, when the material is a mixture of methylmethacrylate(MMA) and benzylmethacrylate(BzMA) to make an MMA-BzMA copolymer, the reaction temperature may range from 50 to 150° C., preferably about 60° C. at the beginning stage of the reaction and about 100° C. at the later stage near the completion of the polymerization reaction.

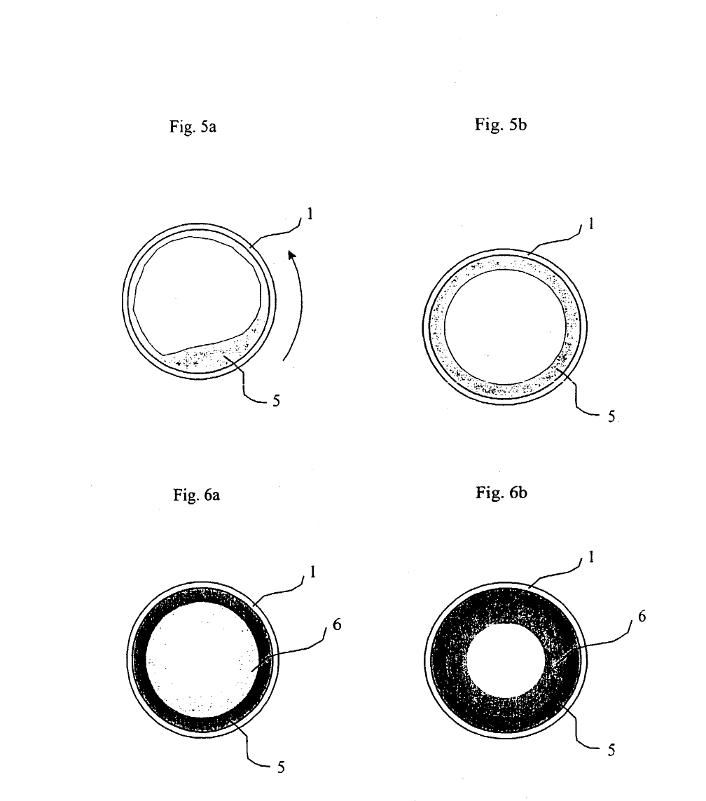

When the rotational axis of the reactor is horizontal, perpendicular to the direction of the gravity and the rotational speed of the reactor is too low, most of the material in the reactor will gather at the lower part of the reactor as in FIG. 5a, if its viscosity is low. As the polymerization reaction proceeds, however, the viscosity of the material increases and, as a result, the material distributes itself evenly on the inner wall of the reactor resulting in an axisymmetric layer shape as in FIG. 5b. When the material distribution attains this axisymmetric shape, it is an indication that the conversion of the polymerization reaction is high and that it is ready for the charging of the next step material.

If the entire reaction system is blanketed by an inert gas to avoid the contact of the reacting material with air, it is not necessary to close the injection port. Otherwise, it is desirable to close the injection port to prevent the material from contamination and oxidation by air.

The material charged into the reactor in the second step may be different from that of the first step or may be a mixture of the same materials with a different mixing composition. When the second-step material is charged, the reactor may be rotated or stopped depending on the viscosity of the first layer. Since it is desirable to maintain the axisymmetric shape of the material interface, it is preferable to charge the material while the reactor is being rotated.

Once the second-step material is charged into the reactor, a polymerization reaction is induced by UV-radiation and/or by heating the material in the reactor while the reactor is being rotated, as in the first step.

This charging and reaction step may be repeated as many times as desired to prepare the rod type polymer preform of the present invention. FIG. 3a is a schematic profile of a radially-varying property of a preform made by repeating the charge-and-react step four times, wherein the reaction in each step was carried out to the extent of nearly 100%, whereas FIG. 3b is a schematic profile obtained when the extent of the conversion of the reaction in each of the four steps was smaller than the case described in FIG. 3a.

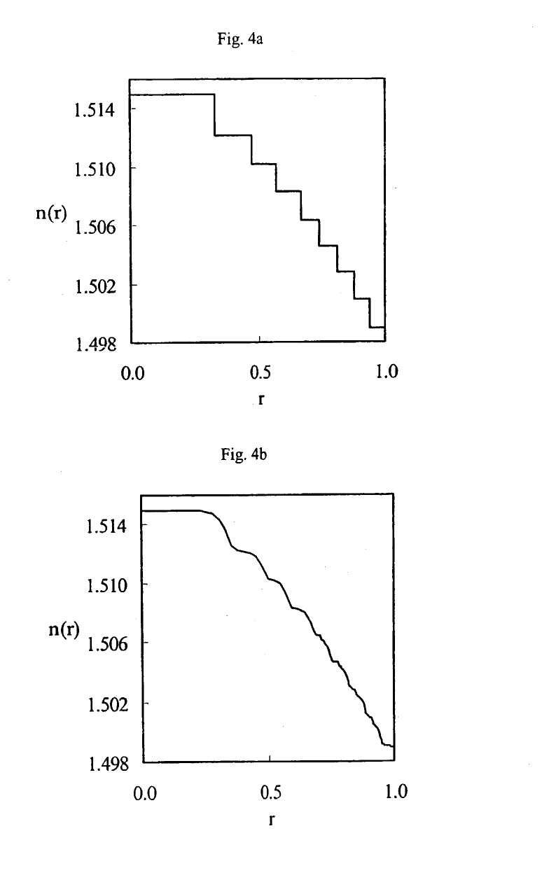

FIG. 4a is a schematic profile of a radially-varying property when the preform is made by repeating the charge-and-react step nine times, the reaction in each step being carried out to the extent of nearly 100% conversion, whereas FIG. 4b is a schematic profile obtained when the extent of the conversion of the reaction in each of the nine steps was smaller than the case described in FIG. 4a.

FIG. 6a is a schematic view of the cross-section of the materials in the reactor which represents a rather sharp interface between the first and second layers, the sharp interface being produced due to the high degree of conversion of the first-layer material(5) prior to charging of the second-layer material(6). FIG. 6b, on the other hand, is a schematic view of the cross-section of the materials in the reactor which represents a fuggy interface between the first and second layers which is not as clear as in FIG. 6a. Such a fuggy interface is produced when the conversion of the first layer material(5) is kept at a lower level than the case of FIG. 6a prior to charging of the second layer material(6).

One of the most important features of the present invention is its capability to control the properties of the preform in the radial direction by adjusting the relative amount of the materials being charged and the conversion of the reaction in each step. The materials used in each step can be monomers, mixtures of two or more materials, prepolymers or oligomers. If the materials used in neighboring steps are incompatible with each other, the reaction in each step can be performed to near completion creating a multistep-index profile as in FIG. 3a, thereby eliminating the possibility of phase separation. To create a smoothened profile as in FIG. 3b, on the other hand, the only requirement is the compatibility between the materials used for the neighboring layers. Consequently, a broad range of materials can be used in the inventive process, making it possible to prepare a preform with a significant variation of the material properties across the radial direction.

The radially-varying material property of the preform in the present invention is not limited to refractive index, and the method of the present invention may be applied to create a radial variation of many other physico-chemical properties including tensile strength, color, thermal expansion coefficient, and porosity. In addition, the application of the present invention is not limited to polymeric materials, and can be extended to metallic and ceramic materials. For example, if the concentration of ceramic particles is increased along the outward direction in a matrix, a state-of-the-art product with an excellent heat resistance and abrasion resistance may be obtained. Also, if two ceramic suspensions are used as inner and outer materials, there may be provided a product with good hardness at the surface with minimal influence by the thermal stress resulting from the differences in the thermal expansion coefficient. The ceramic may be alumina, zirconium or others. Such ceramic materials with radially-varying properties are known as Functionally Gradient Materials (FGMs).

The rod type polymer preform prepared in accordance with the present invention may be conventionally transformed into a graded-index plastic optical fiber (GI-POF) by thermal drawing process, and to a relatively thick strand to produce GI rod lenses. In addition, in accordance with the present invention, a refractive index profile which increases from the center of a preform to its outer edge may be created by reversing the order of the materials being charged in each step. Such a preform with the inverted gradient of the refractive index may be used to make negative-gradient which may be used to correct the aberration in optics. Such negative-gradient lens may be of a large diameter with a small thickness or it can be a rod lens.

The following Examples are given for the purpose of illustration only and are not intended to limit the scope of the invention.

### EXAMPLE 1

A rod type polymer preform with radially-varying properties has been prepared in accordance with the present invention.

This specific embodiment adopted four steps of charging and reacting the material, and mixtures of methylmethacrylate (MMA) and benzylmethacrylate (BzMA) monomers with different mixing compositions were used in each step.

In the first step, a monomer mixture consisting of 90 wt % of methylmethacrylate (MMA) and 10 wt % of benzylmethacrylate (BzMA) was used. The volume of the mixture charged into the reactor was ¼ of the total volume of the reactor after compensating for the volume shrinkage of about 20% that occur during the polymerization reaction. After the material was charged into the reactor (as shown in FIG. 2), the polymerization reaction was induced at a reaction temperature of 60° C. while rotating the reactor at a rate of 200 rpm. When the viscosity of the material in the reactor increased to about 100,000 centipoise (cp) as the polymerization reaction proceeded, the reaction temperature was raised gradually to 100° C. When the viscosity of the material reached about 200,000 cp with further reaction, the reactor temperature was lowered to 60° C. and the second-step material was charged into the reactor. The inner surface of the tubular first layer of reacted material was of a circular shape, and its radial position from the center of the reactor was at about 87% of the radius of the reactor. Thus, the thickness of the tubular reacted material corresponded to 13% of the reactor radius.

The material for the second step was a monomer mixture of MMA and BzMA with a mixing ratio of 84 wt % to 16 wt %. Its volume was the same as that of the first step. As in the first step, the rotational speed was fixed at 200 rpm and the reaction temperature was maintained at 60° C. until the viscosity of the second-step material reached 100,000 cp. The reaction temperature was then raised gradually to 100° C. Once the viscosity of the material reached above 200,000 cp, the reaction temperature was lowered to 60° C. and the third-step material was put in the reactor. The radial position of the inner surface of the second layer was at about 71% of the radius of the reactor. The state of the interface between the first and second layers may be controlled by adjusting the degree of the first polymerization reaction before carrying out the second polymerization reaction. In this specific embodiment, however, as the second-step material is a good solvent for the first-layer material, interlayer mixing occurred to a certain extent and the state of the interface was similar to FIG. 6b rather than FIG. 6a.

The third-step material was also a monomer mixture of MMA and BzMA having a different mixing ratio of 78 wt % to 22 wt %. The total volume charged was the same as the previous steps. As in the previous steps, the reaction temperature was set at 60° C. initially and raised to 100° C. and then decreased back to 60° C. using the same viscosity criterion. Subsequently, the fourth-step material was charged into the reactor. Since the volume of the third-step material was also ¼ of the reactor volume after the volume shrinkage compensation, the radial position of the inner surface of the third layer was at 50% of the radius of the reactor.

The fourth-step material was also a monomer mixture of MMA and BzMA having a mixing ratio of 70 wt % to 30 wt %. The total volume of the material for this step was just enough to fill the remaining volume of the reactor. Thus, it was ¼ of the reactor volume before volume shrinkage compensation. In order to fill up the reactor, the apparatus was tilted vertically making the injection port facing upward. To minimize the distortion of the interfaces between the layers due to gravity, the reactor was rotated at a much higher speed of 1500 rpm. Once the fourth-step material was charged into the reactor, the apparatus was set back to the horizontal position and the rotational speed was reduced to 200 rpm. The reaction temperature was 60° C. initially and was raised gradually to 125° C. to complete the polymerization reaction.

Once the reaction was complete, the reactor temperature was lowered to below the glass transition temperature and the solidified preform was removed from the reactor. Due to the volume shrinkage of the material during the polymerization reaction, a deep dimple was formed at one end of the preform where the injection port was located. In order to prevent the formation of voids at arbitrary locations, a small bubble was left at the material injection side of the reactor which grew bigger as the reaction proceeded, thus acting as a site to absorb the volume shrinkage.

Used in all four steps was 2,2-Azobisisobutyronitrile (AIBN) as an initiator of the polymerization reaction and n-butane thiol as a chain transfer agent in amounts of 0.08 wt % and 0.2 wt %, based on the total amount of the monomer mixture used, respectively.

Since MMA and BzMA have similar reactivity, the preform obtained in this embodiment was an amorphous random copolymer of MMA and BzMA, and the relative concentration of BzMA changed from 30% to 10% in the radial direction from the center. Further, the refractive index of the MMA-BzMA copolymer is about 1.515 and 1.500 at the relative composition of 70% to 30% and 90% to 10%, respectively. Thus, the refractive index of the preform prepared in this embodiment varied from 1.515 at the center to 1.500 at the edge. The refractive index profile of this perform was similar to FIG. 3b.

This preform was turned into a GI-POF of 0.5 mm in diameter by a conventional thermal drawing process. The bandwidth of this GI-POF was masured to be 435 Mbits/s-100 m.

### EXAMPLE 2

The procedure of Example 1 was repeated except each polymerization step was carried out to nearly 100% conversion so that the shape of the refractive index profile of the perform obtained in this example was similar to FIG. 3a, and the bandwidth of a 0.5 mmΦ GI-POF drawn therefrom was 220 Mbits/s-100 m.

### EXAMPLE 3

This embodiment adopted nine steps of material charging and reaction, and mixtures of methylmethacrylate (MMA) and benzylmethacrylate (BzMA) monomers with different mixing compositions were used. The MMA/BzMA mixing compositions used in nine sequential steps were 91:9, 90:10, 87:13, 85:15, 82:18, 80:20, 77:23, 75:25, and 71:29, respectively. All procedures for each step were essentially the same as those of Example 1, and a cylindrical preform with the refractive index profile similar to FIG. 4b was obtained.

The preform was then converted to a GI-POF of 0.5 mm in diameter by a conventional thermal drawing process, and the bandwidth of the GI-POF was 600 Mbits/s-100 m

### EXAMPLE 4

The procedure of Example 3 was repeated except each polymerization step was carried out to nearly 100% conversion so that the shape of the refractive index profile of the perform obtained in this example was similar to FIG. 4a, and the bandwidth of a 0.5 mmΦ GI-POF drawn therefrom was 415 Mbits/s-100 m.

### EXAMPLE 5

This embodiment adopted seven steps of material charging and reaction, and mixtures of methylmethacrylate (MMA) and benzylmethacrylate (BzMA) monomers with different mixing compositions were used. 1-hydroxycyclohexyl phenyl ketone (HCPK) was used as the initiator, and dodecane thiol was used as the chain transfer agent.

The first-step material was methylmethacrylate (MMA) without any benzylmethacrylate (BzMA), and the volume of this material charged into the reactor was 64% of the total volume of the reactor after compensating for the volume shrinkage of about 20% that occur during the polymerization reaction. After the material was charged into a reactor (as shown in FIG. 2), polymerization reaction was induced by ultraviolet radiation at room temperature while rotating the reactor at a speed of 500 rpm. When the viscosity of the material in the reactor became high enough not to flow when the rotation was stopped, the second-step material was charged into the reactor. The inner surface of the tubular first layer of reacted material was of a circular shape, and its radial position from the center of the reactor was at about 43% of the radius of the reactor. Thus, the thickness of the tubular reacted material corresponded to 57% of the reactor radius.

The material for the second step was a monomer mixture of MMA and BzMA with the mixing ratio of 95 wt % to 5 wt %. Its volume was 6% of the total reactor volume. As in the first step, the rotational speed was fixed at 500 rpm and the reaction was induced by the same UV radiation at room temperature. When the viscosity became high enough not to flow when the rotation was stopped, the third-step material was charged into the reactor. The radial position of the surface was at about 40% of the radius of the reactor.

The procedures for the third to. the sixth step were exactly the same as the second-step except the material composition. The compositions of the MMA/BzMA mixture were 91:9, 87:13, 83:17 and 79:21 for the third, fourth, fifth and the sixth step, respectively.

The material for the final step (i.e., seventh step) was also a monomer mixture of MMA and BzMA with a mixing ratio of 75 wt % to 25 wt %. The total volume of the material for this step was just enough to fill the remaining volume of the reactor which was about 6% of the total reactor volume. This material was charged while the reactor was tilted vertically, and the reactor was brought back to the horizontal position after charging the material. The reaction was induced again by the UV radiation at room temperature while rotating the reactor at a somewhat higher speed of 600 rpm.

Once the reaction was complete, a solid-phase preform was removed from the reactor. The preform was then drawn into GI-POF of 0.5 mm in diameter by a conventional thermal drawing process. The measured bandwidth of this GI-POF was 520 Mbits/s-100 m.

While the invention has been described in connection with the above specific embodiments, it should be recognized that various modifications and changes may be made to the invention by those skilled in the art without departing from the scope of the invention as defined by the appended claims.

What is claimed is:

1. A method of preparing a rod type polymer preform with at least one radially-varying property, which comprises charging one or more reactive materials into a cylindrical reactor, polymerizing the charged materials while rotating said reactor and repeating said charging and polymerizing processes more than two times, wherein said reactive materials used in said processes are either chemically or compositionally different.

2. The method according to claim 1, wherein the cross-section of said preform is of a circular, elliptical, triangular, rectangular, pentagonal or other geometrical shape.

3. The method according to claim 1, wherein said reactor is rotated at a rate ranging from 10 to 2,000 rpm.

4. The method according to claim 1, wherein said reactive material is a monomer, homopolymer, copolymer or a mixture thereof.

5. The method according to claim 4, wherein said monomer is selected from the group consisting of methylmethacrylate, benzylmethacrylate, phenylmethacrylate, 1-methylcyclohexylmethacrylate, cyclohexyl-methacrylate, chlorobenzylmethacrylate, 1-phenylethylmethacrylate, 1,2-diphenylethylmethacrylate, diphenylethylmethacrylate, furfuryl-methacrylate, 1-phenylcyclohexylmethacrylate, pentachlorophenyl-methacrylate, pentabromophenylmethacrylate, styrene, perfluoro-2,2-dimethyl-1,3-dioxole, tetrafluoroethylene, chlorotrifluoroethylene, vinylidene fluoride, hexafluoropropylene, trifluoroethylene, perfluoroallyl vinyl ether, and fluorovinyl ether.

6. The method according to claim 4, wherein said homopolymer is a polymer derived from the monomer recited in claim 5.

7. The method according to claim 4, wherein said copolymer is selected from the group consisting of methylmethacrylate(MMA)-benzylmethacrylate(BMA), styrene-acrylonitrile(SAN), methylmethacrylate(MMA)-2,2,2-trifluoroethyl-methacrylate(TFEMA), methylmethacrylate(MMA)-2,2,3,3,3-pentafluoropropylmethacrylate (PFPMA), methylmethacrylate(MMA)-1,1,1,3,3,3-hexafluoroisopropyl-methacrylate(HFIPMA), methylmethacrylate (MMA)-2,2,3,3,4,4,4-heptafluorobutylmethacrylate(HFBMA), trifluoroethylmethacrylate (TFEMA)-pentafluoropropylmethacrylate(PFPMA), trifluoroethylmethacrylate(TFEMA)-hexafluoroisopropylmethacrylate(HFIP MA), trifluoroethylmethacrylate(TFEMA)-heptafluorobutylmethacrylate (HFBMA); copolymers polymerized with a first monomer of perfluoro-2,2-dimethyl-1,3-dioxole and a second monomer selected from the group consisting of tetrafluoroethylene, chlorotrifluoroethylene, vinylidene fluoride, hexafluoropropylene, trifluoroethylene, perfluoroallyl vinyl ether and fluorovinyl ether; and copolymers polymerized with a first monomer of perfluoroallyl vinyl ether and a second monomer selected from the group consisting of perfluoro-2,2-dimethyl- 1,3-dioxole, tetrafluoroethylene, chlorotrifluoroethylene, vinylidene fluoride, hexafluoropropylene, trifluoroethylene and fluorovinyl ether.

8. The method according to claim 4, wherein said copolymer is a terpolymer obtained by polymerizing perfluoro-2,2-dimethyl-1,3-dioxole with two other monomers each selected from the group consisting of tetrafluoroethylene, chlorotrifluoroethylene, vinylidene fluoride, hexafluoropropylene, trifluoroethylene, perfluoroallyl vinyl ether and fluorovinyl ether; or a terpolymer obtained by polymerizing perfluoroallyl vinyl ether with two additional monomers each selected from the group consisting of perfluoro-2,2-dimethyl- 1,3-dioxole, tetrafluoroethylene, chlorotrifluoro-ethylene, vinylidene fluoride, hexafluoropropylene, trifluoroethylene, perfluoroallyl vinyl ether and fluorovinyl ether.

9. The method according to claim 1, wherein said property is an optical property.

10. The method according to claim 9, wherein said optical property is the index of refraction.

11. An apparatus for preparing a rod type polymer preform with at least one radially-varying property, which comprises a cylindrical reactor; sealing members for sealing both ends of the reactor; an injection port installed on the reactor to charge reactive materials into the reactor; a rotating device to rotate the reactor; and a means for inducing the chemical reaction of the materials charged into the reactor.

12. The apparatus according to claim 11, wherein the cross-section of said reactor is of a circular, elliptical, triangular, rectangular, pentagonal or other geometrical shape.

13. The apparatus according to claim 12, wherein the cross section of the reactor is circular and its inside diameter ranges from 1 cm to 15 cm.

14. The apparatus according to claim 11, wherein the means for inducing the chemical reaction is a heating device to maintain said reactor at a set temperature range, an ultraviolet (UV) radiation device to radiate UV to said reactor, or a combination thereof.

15. A rod type polymer preform with at least one radially-varying property prepared by the method according to any one of claims 1 to 10.

16. A rod type polymer preform with at least one radially-varying property prepared using the apparatus according to any one of claims 11 to 14.

17. A plastic optical fiber prepared by thermal drawing the rod type polymer preform according to claim 15 or 16.

18. The plastic optical fiber according to claim 17, wherein said fiber is a multistep-index or a graded-index type.

19. An optical lens prepared by cutting and polishing the rod type polymer preform according to claim 15 or 16.

20. The optical lens according to claim 19, wherein said lens is a multistep-index or a graded-index type.
